(19) United States
(12) Patent Application Publication
(10) Pub. No.: US 2012/0005207 A1
(43) Pub. Date: Jan. 5, 2012

(54) METHOD AND SYSTEM FOR WEB EXTRACTION

(75) Inventors: Pankaj Gulhane, Bangalore (IN); Srinivasan Hanumantha Rao Sengamedu, Bangalore (IN); Ashwin Tengli, Bangalore (IN); Rajeev Rastogi, Bangalore (IN)

(73) Assignee: Yahoo! Inc., Sunnyvale, CA (US)

(21) Appl. No.: 12/828,305

(22) Filed: Jul. 1, 2010

(51) Int. Cl. G06F 17/30

(52) U.S. Cl. 707/737; 707/780; 707/E17.014; 707/E17.089

(57) ABSTRACT

A method includes generating, a plurality of sets of pairs of records from a set of records, for each attribute-position pair in the set of records. Each attribute-position pair being indicative of a position of an attribute in a record. Further, the method includes forming, electronically, a plurality of groups, each group comprising two attribute-position pairs having different attributes. Further, the method also includes determining, electronically for each group, number of pairs of records that are common in the two attribute-position pairs of that group. Furthermore, the method includes extracting results based on a first group of the plurality of groups if the number of pairs of records that are common in the two attribute-position pairs of the first group is greater than a second threshold, is highest among the plurality of groups, and no group having three or more attribute-position pairs with different attributes is possible.

### BACKGROUND

Over the years, various web extraction techniques have incorporated trained models for performing extraction of web pages. Essentially, the training of models involves manually annotating few sample pages and generating rules based on annotated pages. This can be a labour intensive and a time consuming process.

In recent years, there have been developments of machine learning models that perform web extraction, for example Markov Logic Networks. Few of the machine learning models utilizes the structural and content features of the web pages to label data. The labeled data is used to train the machine learning models and generate the rules for extraction. The rules are then utilized for matching records to web pages. However, training good machine learning models is a challenge since the structural and content features of the web pages vary across websites.

One existing method of matching records is explained in conjunction with FIG. 1. Consider a database 105. The database 105 includes two attributes, for example NAME and ADDRESS, of restaurants. The database 105 includes a record, for example r1. Exemplary webpage 110 and webpage 115 can be available over a network. The webpage 110 and the webpage 115 have name and address of the restaurants that are denoted by position 120 and 125 respectively. Further, the webpages also include nearest transit to the restaurant and related restaurants that correspond to address and name attributes respectively. The positions for the nearest transit and the related restaurants are denoted by 130 and 135.

The name and address of restaurant in the webpage 110 and record r1 belong to same real-world entity, which is Beijing Bites restaurant. Similarity computation techniques can be used to compute the similarity score for an attribute “A” between attribute values of the data record 105 and the webpage 110. For example, using a Jaccard similarity technique the similarity scores can be computed for two sets S1 and S2 as

$$JC ( S 1 , S 2 ) = \frac{\vert S 1 ⋂ S 2 \vert}{\vert S 1 ⋃ S 2 \vert}$$

The similarity score (6/13) between value of ADDRESS attribute in the record r1 and value of ADDRESS attribute in the webpage 110, denoted at the position 125, belonging to the same real-world entity is low due to additional line “between 28th and 29th St” (noise) in the ADDRESS attribute in the webpage 110 and due to presence of acronym “Ave” in the webpage 110. Similarly, value of the NAME attribute in the record r1 and value of the NAME attribute in the webpage 110, denoted at the position 120, belonging to the same real-word entity has low similarity score of ⅓ due to wrong spelling of Beijing as Bejing (noise) in the webpage 110. However, a string “China Club” at the position 135 in the webpage 115 has a high similarity score (1) with the value of NAME attribute in the record r2. Hence, extraction of results based on the similarity scores may return wrong results and are error prone in presence of noise in webpages.

In light of the foregoing discussion there is a need for a method and system for matching records to web pages.

### SUMMARY

An example of a method includes generating, electronically, a plurality of sets of pairs of records from a set of records, the plurality of sets of pairs of records comprising a first set of pairs of records and a second set of pairs of records, each pair of records from the first set of pairs of records having a similarity score greater than a first threshold for a first attribute-position pair in that pair of records and each pair of records from the second set of pairs of records having a similarity score greater than the first threshold for a second attribute-position pair in that pair of records, each attribute-position pair being indicative of a position of an attribute in a record. The method also includes performing generating sets of pairs of records for each attribute-position pair in the set of records. Further, the method includes forming, electronically, a plurality of groups, each group comprising two attribute-position pairs having different attributes. Further, the method also includes for each group determining, electronically, number of pairs of records that are common in the two attribute-position pairs of that group. Furthermore, the method includes extracting results based on a first group of the plurality of groups if the number of pairs of records that are common in the two attribute-position pairs of the first group is greater than a second threshold, is highest among the plurality of groups, and no group having three or more attribute-position pairs with different attributes is possible.

Another example of a method for extracting results include computing, electronically, a first set of similarity scores between attribute values of a seed record and of a web page, the seed record comprised in a set of seed records and the web page comprised in a set of web pages. The method also include performing computing for each record in the set of seed records and each web page in the set of web pages to generate a plurality of sets of similarity scores, the plurality of set of similarity scores comprising the first set of similarity scores. For a first position of a first attribute in the set of web pages, the method includes identifying, electronically, number of web pages for which attribute values at the first position match that in the set of seed records based on the plurality of sets of similarity scores and determining, electronically, the first position of an attribute as a correct position if the number of web pages for which attribute values at the first position match that in the set of seed records is greater than a threshold. Further, the method includes performing identifying and determining for each position of each attribute in the set of web pages to determine correct position for each attribute, the correct position comprising first position for the first attribute. Further, the method also include extracting web pages from the set of web pages based on the first position of the first attribute, the web pages having attribute value in the first position similar to that in a seed record of the set of seed records for the first attribute. Furthermore, the method includes performing extracting for each correct position for each attribute.

An example of an article of manufacture includes a machine-readable medium, and instructions carried by the machine-readable medium. The machine-readable medium is operable to cause a programmable processor to generate a plurality of sets of pairs of records from a set of records. The plurality of sets of pairs of records includes a first set of pairs of records and a second set of pairs of records, each pair of records from the first set of pairs of records having a similarity score greater than a first threshold for a first attribute-position pair in that pair of records and each pair of records from the second set of pairs of records having a similarity score greater than the first threshold for a second attribute-position pair in that pair of records. Each attribute-position pair is indicative of a position of an attribute in a record. Generating sets of pairs of records is performed for each attribute-position pair in the set of records. Further, a plurality of groups is formed, each group including two attribute-position pairs having different attributes. For each group, number of pairs of records that are common in the two attribute-position pairs of that group are determined. Furthermore, the results are extracted based on a first group of the plurality of groups if the number of pairs of records that are common in the two attribute-position pairs of the first group is greater than a second threshold, is highest among the plurality of groups, and no group having three or more attribute-position pairs with different attributes is possible.

An example of a system includes a database for storing a set of records. The system also includes a communication interface in electronic communication with a network to receive records. The system also includes a memory for storing instructions. Further, the system includes a processor responsive to the instructions to generate a plurality of sets of pairs of records from the set of records. The plurality of sets of pairs of records includes a first set of pairs of records and a second set of pairs of records, each pair of records from the first set of pairs of records having a similarity score greater than a first threshold for a first attribute-position pair in that pair of records and each pair of records from the second set of pairs of records having a similarity score greater than the first threshold for a second attribute-position pair in that pair of records. Each attribute-position pair being indicative of a position of an attribute in a record. The processor also performs generating sets of pairs of records for each attribute-position pair in the set of records. Further, the processor forms a plurality of groups, each group comprising two attribute-position pairs having different attributes. For each group, the processor then determines a number of pairs of records that are common in the two attribute-position pairs of that group. Furthermore the processor also extracts results based on a first group of the plurality of groups if the number of pairs of records that are common in the two attribute-position pairs of the first group is greater than a second threshold, is highest among the plurality of groups, and no group having three or more attribute-position pairs with different attributes is possible.

### BRIEF DESCRIPTION OF FIGURES

FIG. 1 is an exemplary illustration of a database and webpages;

FIG. 2 is a block diagram of an environment, in accordance with one embodiment;

FIG. 3 illustrates a block diagram of a server, in accordance with one embodiment;

FIG. 4 is a flowchart illustrating a method for matching records, in accordance with one embodiment;

FIG. 5 is a flowchart illustrating a method for extracting results, in accordance with one embodiment; and

FIG. 6 is another exemplary illustration of a database and webpages.

### DETAILED DESCRIPTION OF THE EMBODIMENTS

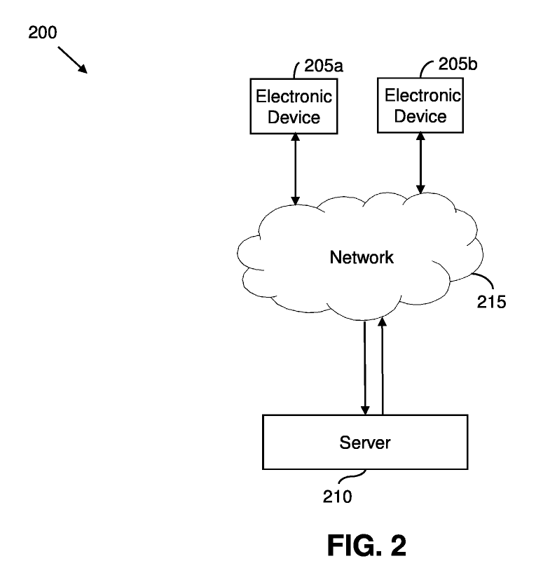

FIG. 2 is a block diagram of an environment 200, in accordance with one embodiment. The environment 200 includes one or more electronic devices, for example, an electronic device 205A and an electronic device 205B connected to a server 210, hereinafter referred to as the server 210, through a network 215. The server 210 can also be a web server.

Examples of the electronic devices include, but are not limited to, computers, mobile devices, laptops, palmtops, internet protocol televisions (IPTVs) and personal digital assistants (PDAs). Examples of the network 215 include, but are not limited to, a Local Area Network (LAN), a Wireless Local Area Network (WLAN), a Wide Area Network (WAN), wired network, wireless network, internet and a Small Area Network (SAN).

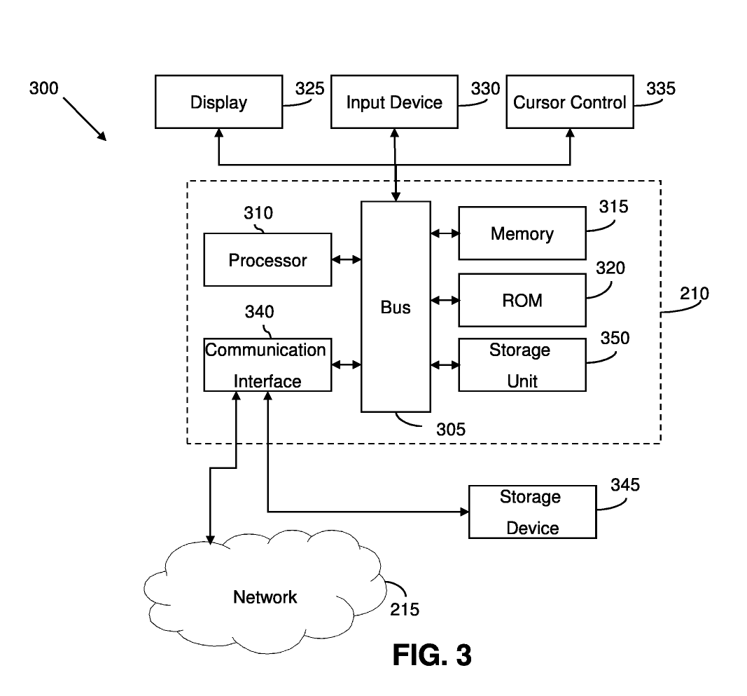

The server 210 processes data and can include one or more hardware elements. The server 210 including hardware elements are explained in detail in conjunction with FIG. 3.

In one embodiment, a user of the electronic device 205A inserts a search query through search website, for example Y! Search. The query can include key words. The query is received by the server 210. The server 210 then processes the data. The processing of data includes computing similarity scores for a plurality of attributes, hereinafter referred to as the attributes. The similarity scores are computed between attribute values of set of records stored in a database and the attribute values of an input set of webpages. A record includes an attribute name and an attribute value. The record corresponds to a real-life entity or a real world entity or an entity, hereinafter referred to as the entity. For example, Beijing Bites restaurant is an entity. Entity can include a physically known thing. Entity can also include things that have existence though not a material or physical existence. For example, entity can be defined by a set of attributes. The attribute is a specification that defines a property of an entity, an object, an element, or a file. For a schema for an event, the event can be an entity defined using attributes of the schema. The attributes of the schema can include “when”, “where”, “dress style”, “ticket price” and so on. The attribute names corresponding to restaurant can include “NAME” and “ADDRESS”. Values corresponding to each of the attribute names can be referred to as attribute values. For example, for Beijing Bites restaurant attribute value for NAME can be “Beijing Bites” and attribute value for ADDRESS can be “120 Lexington Avenue New York, N.Y. 10016”. The database can be present in the server 210 or in a storage unit that is in electronic communication with the server 210. The webpages can be from a single website or multiple websites. For webpages from multiple websites, the processing can be performed individually on each website based on decreasing order of the website size. The server 210 then identifies position matches in the input set of webpages for each position of the attributes in the set of seed records. The position matches can be further pruned using the similarity scores. Further, the server 210 determines position of the attributes as a correct position if the number of web pages for which attribute values at the position match that in the set of seed records is greater than a threshold. Upon determining correct positions for the attributes, the server 210 extracts the web pages from the set of web pages. The extraction of content further facilitates various applications, for example providing search results or any further processing of extracted content.

FIG. 3 illustrates a block diagram of the server 210, in accordance with one embodiment. The server 210 includes a bus 305 for communicating information, and a processor 310 coupled with the bus 305 for processing information. The server 210 also includes a memory 315, for example a random access memory (RAM) coupled to the bus 505 for storing instructions to be executed by the processor 310. The memory 315 can be used for storing temporary information required by the processor 310. The server 210 further includes a read only memory (ROM) 320 or other static storage unit coupled to the bus 305 for storing static information and instructions for processor 310. A storage unit 350, such as a magnetic disk or hard disk, can be provided and coupled to the bus 305 for storing information.

The server 210 can be coupled via the bus 305 to a display 325, for example a cathode ray tube (CRT) or liquid crystal display (LCD), for displaying information. An input device 330, including various keys, is coupled to the bus 305 for communicating information and command selections to the processor 310. In some embodiments, cursor control 335, for example a mouse, a trackball, a joystick, or cursor direction keys, for command selections to the processor 310 and for controlling cursor movement on the display 325 can also be present. The functioning of the input device 330 can also be performed using the display 325, for example a touch screen.

Various embodiments are related to the use of the server 210 for implementing the techniques described herein, for example in FIG. 3. The techniques can be performed by the server 210 in response to the processor 310 executing instructions included in the memory 315. The instructions can be read into the memory 315 from another machine-readable medium, such as the storage unit 350. Execution of the instructions included in the memory 315 causes the processor 310 to perform the techniques described herein.

The term machine-readable medium can be defined as a medium providing data to a machine to enable the machine to perform a specific function. The machine-readable medium can be a storage media. Storage media can include non-volatile media and volatile media. The memory 315 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

In some embodiments, the machine-readable medium can be transmission media including coaxial cables, copper wire and fiber optics, including the wires that include the bus 305. Transmission media can also take the form of acoustic or light waves, such as those generated during radio-wave and infra-red data communications. Examples of machine-readable medium may include but are not limited to carrier waves as describer hereinafter or any other media from which the server 210 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 210 can receive the data on the telephone line and use an infra-red transmitter to convert the data to an infra-red signal. An infra-red detector can receive the data carried in the infra-red signal and appropriate circuitry can place the data on the bus 305. The bus 305 carries the data to the memory 315, from which the processor 310 retrieves and executes the instructions. The instructions received by the memory 315 can optionally be stored on the storage unit 350 either before or after execution by the processor 310. All such media must be tangible to enable the instructions carried by the media to be detected by a physical mechanism that reads the instructions into a machine.

The server 210 also includes a communication interface 340 coupled to the bus 305 for enabling data communication. Examples of the communication interface 340 include, but are not limited to, an integrated services digital network (ISDN) card, a modem, a local area network (LAN) card, an infrared port, a Bluetooth port, a zigbee port, and a wireless port.

The server 210 can be coupled to a storage device 345 that stores the database of the set of records. In some embodiments, the database can be stored in the server 210.

In some embodiments, the processor 310 can include one or more processing units for performing one or more functions of the processor 310. The processing units are hardware circuitry performing specified functions.

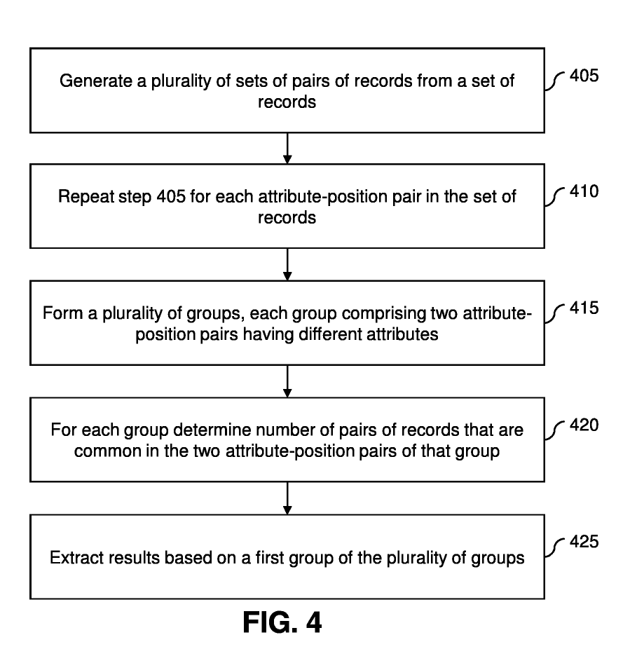

FIG. 4 is a flowchart illustrating a method for matching records, in accordance with one embodiment.

A webpage can be represented as a document object model (DOM) tree that includes plurality of nodes. For a node n in the webpage, let x be the unique path from the root to n in the DOM tree. The path x denotes the position of node n in the webpage, for example a webpage ‘p’. Further, p[x] is used to denote the value of the node n at the position x in the page p. For a leaf node, the value is essentially the text string included in the leaf node. If n is an internal node, then the value is the concatenated sequence of text from the leaves of the subtree rooted at n (in the order in which the nodes appear in the DOM tree). Herein, the nodes and the corresponding node values can be represented as attributes and attribute values respectively.

A set of records is populated in a database (set of seed records) represented by R. The records are extracted from few websites by annotating the attribute values in a few sample pages from each of the few websites. Wrappers can then be learned or created based on the annotating of the few websites.

Each record within the set of records includes plurality of attributes and corresponding attribute values. Further, each record is associated with websites from which the records are extracted.

The method illustrated in FIG. 4 is performed by the server 110 on receiving webpages from a website. The server 110 analyses the webpages of the website for the attribute values that match attribute values in the set of records.

At step 405, a plurality of sets of pairs of records is generated electronically, from the set of records, for example using the server 110. The plurality of sets of pairs of records includes a first set of pairs of records and a second set of pairs of records.

Each pair of records from the first set of pairs of records have a similarity score greater than a first threshold for a first attribute-position pair in that pair of records. Similarly, each pair of records from the second set of pairs of records have a similarity score greater than the first threshold for a second attribute-position pair in that pair of records. Each pair of records includes a record stored in the database R and the webpage from the website. Each attribute-position pair is indicative of a position of an attribute in the record.

The first attribute-position pair and the second attribute-position pair correspond to a same attribute at different positions.

The similarity scores can be computed using one of jaccard similarity algorithm and Q-gram weight algorithm.

In some embodiments, the similarity scores can be computed using a method described in “U.S. patent application Ser. No. 12/721,577 filed on Mar. 11, 2010, entitled “METHOD AND SYSTEM FOR DETERMINING SIMILARITY SCORE”, assigned to Yahoo! Inc”, which is incorporated herein by reference in its entirety.

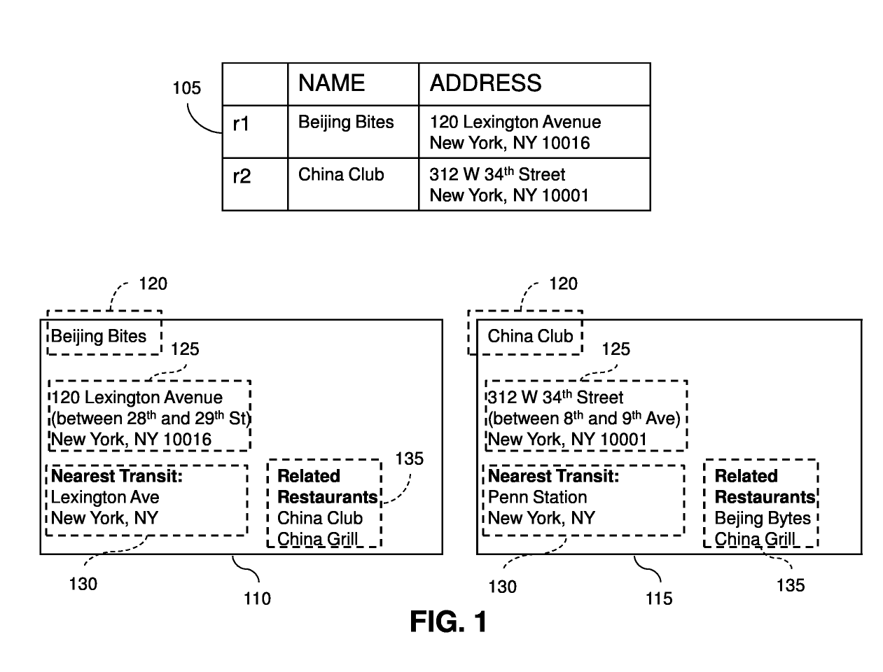

For illustrating the method performed in FIG. 4, let us consider the following example. Consider the database 105 shown in FIG. 1. The database 105 includes the set of records. Also, consider a webpage ‘p1’ 110 and a webpage ‘p2’ 115 from a website W as shown in FIG. 1. The database R includes plurality of records, for example a record ‘r1’ and a record ‘r2’. The plurality of records includes an entry for a name and an address attribute. The record ‘r1’ includes' the name attribute ‘Beijing Bites’ and an address attribute ‘120 Lexington Avenue New York, N.Y. 10016’ and the record ‘r2’ includes the name attribute ‘China Club’ and ‘312 W 34^{th} Street New York, N.Y. 10001’ respectively.

The name and address of the restaurants are provided at the top of the web pages, and the nearest transit station and related restaurants are listed at the bottom.

In the FIG. 1, the position of name, address, nearest transit and related restaurants are denoted as 120, 125, 130, and 135 respectively. For simplicity, the positions 120, 135, 125, and 130 will herein be denoted as 1, 2, 3, and 4 respectively. Here, values at the position 120 and the position 135 correspond to the ‘name’ attribute in the database 105. Further, the values at the position 125 and the position 130 correspond to the ‘address attribute in the database 105.

The webpage p1 110 corresponds to the webpage of a restaurant ‘Beijing Bytes’. The webpage p1 110 also includes the address for the Beijing Bytes (120 Lexington Avenue (between 28^{th} and 29^{th} St) New York, N.Y. 10016), nearest transit (Lexington Ave New York, N.Y.) and the related restaurants (China Club, China Grill).

The webpage p2 115 corresponds to the webpage of a restaurant ‘China Club’. The webpage p2 115 also includes the address for the China Club (312 W 34^{th} Street (between 8^{th} and 9^{th} Ave) New York, N.Y. 10001), nearest transit (Penn Station New York, N.Y.) and the related restaurants (Bejing Bytes, China Grill).

The similarity scores are computed between attribute values at the each position with the set of records. The first set of pairs of records (first set) having the similarity score greater than the first threshold is generated for the name attribute at a first position in the web pages.

The first set is represented as S(name,1)=(r1,p1),(r2,p2)} (1)

The first set represents that the values of the name attribute in records r1 and r2 are strongly similar to the values in position 1 in pages p1 and p2 respectively. Here, (r1, p1) represents that the value at position 120 (Bejing Bytes) in the webpage p1 matches the value of the name attribute (Beijing Bytes) in the record r1. The similarity scores between the values at the position 120 in the webpage p1, and the record r1 crosses the first threshold. Similarly, (r2, p2) represents that the value at position 120 (China Club) in the webpage p2 matches the value of the name attribute in the record r1 (China Club). However, the similarity scores between the values at the position 120 in the webpage p2, and the record r1 does not cross the first threshold. Further, the similarity scores between the values at the position 120 in the webpage p1, and the record r2 also do not cross the first threshold. Hence, (r1, p2) and (r2, p1) are not represented in the first set. It is to be noted that the record pairs (record page pairs) that do not cross the first threshold are not mentioned in the subsequent sets of pairs of records.

The term strongly similar denotes that the similarity scores are greater than the first threshold.

Similarly, the second set of pairs of records (second set) having the similarity score greater than the first threshold is generated for the name attribute at a second position in the web pages.

The second set is represented as S(name,2)={(r2,p1),(r1,p2)} (2)

The second set represents that the values of the name attribute in records r2 and r1 are strongly similar to the values in position 2 in webpages p1 and p2 respectively. Here, (r2, p1) represents that the value at position 135 (China Club China Grill) in the webpage p1 matches the value of the name attribute (China Club) in the record r2. The similarity scores between the values at the position 135 in the webpage p1, and the record r1 crosses the first threshold. Similarly, (r1, p2) represents that the value at position 135 (Bejing Bytes China Grill) in the webpage p2 matches the value of the name attribute (Beijing Bytes) in the record r1.

At step 410, step 405 is repeated for each attribute-position pair in the set of records.

In some embodiments, step 410 and step 405 can be a single step.

In the illustrated example, a third set of pairs of records (third set) and a fourth set of pairs of records (second set) is similarly generated for the address attribute at a third position and fourth position in the web pages respectively.

The third set is represented as S(address,3)={(r1,p1),(r2,p2)} (3)

The third set represents that the value of the address attributes in records r1 and r2 are strongly similar to the values in position 3 in webpages p1 and p2 respectively. Here, (r1, p1) represents that the value at position 125 (120 Lexington Avenue (between 28^{th} and 29^{th} St) New York, N.Y. 10016) in the webpage p1 matches the value of the address attribute (120 Lexington Avenue New York, N.Y. 10016) in the record r1. The similarity scores between the values at the position 125 in the webpage p1, and the record r1 crosses the first threshold. Similarly, (r2, p2) represents that the value at position 125 (312 W 34^{th} Street (between 8^{th} and 9^{th} Ave) New York, N.Y. 10001) in the webpage p2 matches the value of the name attribute in the record r1 (312 W 34^{th} Street New York, N.Y. 10001).

The fourth set is represented as S(address,4)={(r1,p1)} (4)

The fourth set represents that the value of the address attribute in record r1 is strongly similar to the value in position 4 of webpage p1. Here, (r1, p1) represents that the value at position 130 (Lexington Ave New York, N.Y.) in the webpage p1 matches the value of the address attribute (120 Lexington Avenue New York, N.Y. 10016) in the record r1. The similarity scores between the values at the position 125 in the webpage p1, and the record r1 crosses the first threshold.

At step 415, a plurality of groups is formed electronically, each group comprising two attribute-position pairs having different attributes.

The groups are performed for the sets of pairs of records that are generated in the step 305 and the step 310. The groups constitute a pairs of sets, each set in the pairs of sets corresponding to different attributes.

In the illustrated example, a first group S1 is formed constituting the attribute-position pairs (name, 1) and (address, 3) respectively. A second group S2 is formed constituting the attribute-position pairs (name, 1) and (address, 4) respectively. Similarly, two more groups can be formed that are represented by S3={(name, 2), (address, 3)}, and S4={(name, 2), (address, 4)}.

At step 420, for each group, number of pairs of records that are common in the two attribute-position pairs of that group are electronically determined.

In the illustrated example, of the four groups of attribute position pairs, S1 has both pairs of records in common since name and address values in records r1 and r2 will match the values in positions 1 and 2 in pages p1 and p2, respectively. Group S2 has single pairs of records in common since name and address values in only record r1 will match the values in positions 1 and 3 in page p1. Groups S3 and S4 have no pairs of records in common since name and address values do not match values in the records r1 and r2. Commonality between the attribute-position pairs are determined by comparing the attribute values.

At step 425, results are extracted based on the first group of the plurality of groups if the number of pairs of records that are common in the two attribute-position pairs of the first group is greater than a second threshold, is highest among the plurality of groups, and no group having three or more attribute-position pairs with different attributes is possible.

Similarly, the results may be extracted for other groups of the plurality of groups if the number of pairs of records that are common in the two attribute-position pairs of that group is greater than the second threshold, is highest among the plurality of groups, and no group having three or more attribute-position pairs with different attributes is possible. The second threshold can be defined as the minimum support for verifying the webpage as valid. The minimum support is denoted as β. The support of group S is defined as the number of web pages p in website W such that values at position in webpage p match values of attributes in the database R.

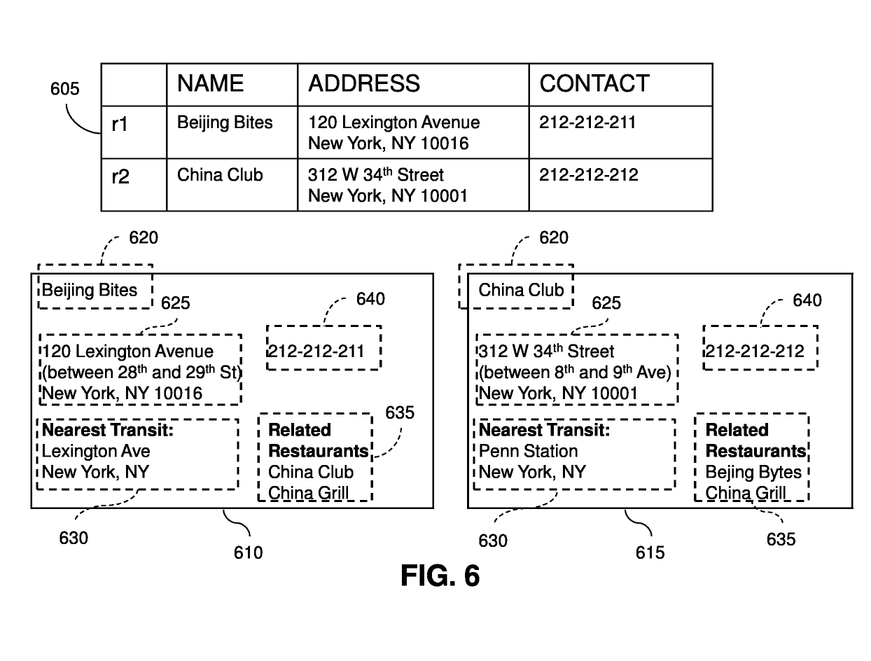

If another group having three or more attribute position pairs with different attributes is possible, then an apriori style algorithm is used in conjunction with the method described in FIG. 4 to arrive at an optimal set of attribute-position pairs that have support greater than the second threshold. An example illustrating the matching of records forming groups having three attributes is explained in FIG. 6.

In the illustrated example, S1 has support 2 since name and address values in records r1 and r2 will match the values in positions 1 and 3 in pages p1 and p2, respectively. S2 has support 1 since name and address values in only record r1 will match the values in positions 1 and 4 in page p1. S3 has zero support since name and address values in either of the records r1 and r2, do not have matches for the values at the position 2 and 3 in pages p1 and p2. S4 has also zero support since name and address values in either of the records r1 and r2, do not have matches for the values at the position 2 and 4 in pages p1 and p2. If a minimum support parameter, defined by β=1 then all but S1 and S2 will be pruned from C2 due to lack of support, and the attribute values of the set S1 will be extracted since it has the maximum support of 2.

The extracted attribute values can be used to create a database of websites that are associated with a set of attribute values. A uniform resource locator (URL) can be associated with each attribute value.

In an embodiment, on receiving a search query, the server 210 queries the database of websites for retrieving relevant websites as results.

In another embodiment, the method described in FIG. 4 can be performed on receiving a search query for extracting the records corresponding to the search query. Further, websites can then be returned corresponding to the matching records.

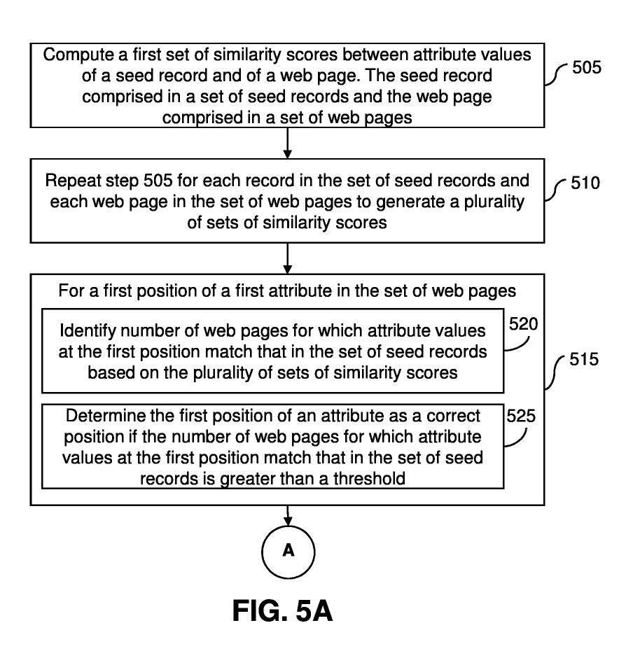

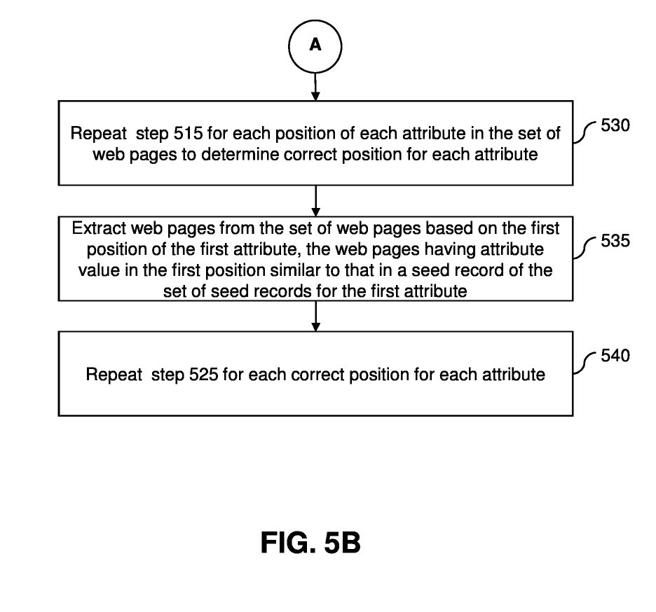

FIG. 5 is a flowchart illustrating a method for extracting results, in accordance with one embodiment.

At step 505, a first set of similarity scores is electronically computed between attribute values of a seed record and of a web page. The seed record being part of a set of seed records and the web page being part of a set of web pages. The set of webpages can correspond to a single website or multiple websites.

The similarity scores can be computed using one of jaccard similarity algorithm and Q-gram weight algorithm.

In some embodiments, the similarity scores can be computed using a method described in “U.S. patent application Ser. No. 12/721,577 filed on Mar. 11, 2010, entitled “METHOD AND SYSTEM FOR DETERMINING SIMILARITY SCORE”, assigned to Yahoo! Inc”, which is incorporated herein by reference in its entirety.

At step 510, repeat step 405 for each record in the set of seed records and each web page in the set of web pages to generate a plurality of sets of similarity scores. The plurality of set of similarity scores includes the first set of similarity scores.

At step 515, perform step 520 and step 525 for a first position of a first attribute in the set of web pages.

At step 520, number of web pages for which attribute values at the first position match that in the set of seed records are electronically identified based on the plurality of sets of similarity scores.

At step 525, the first position of an attribute is electronically determined as a correct position if the number of web pages for which attribute values at the first position match that in the set of seed records is greater than a threshold.

The threshold is defined as the minimum number of pages in which an attribute value matches to the seed record.

At step 530, repeat step 515 for each position of each attribute in the set of web pages to determine correct position for each attribute.

A list of web pages whose attribute values match the seed record at correct positions is determined.

At step 535, the web pages are extracted from the set of web pages based on the first position of the first attribute, the web pages having attribute value in the first position similar to that in a seed record of the set of seed records for the first attribute.

At step 540, extracting is performed for each correct position for each attribute. The correct position for each attribute can determined using the method described in FIG. 4. Upon identifying the correct attribute values, the record containing the attributes are extracted.

The extracted attribute values can be used to learn new wrappers that are subsequently used to extract records from the other input set of webpages. Further, the seed record is augmented with the extracted records that correspond to new attributes of an entity.

In an embodiment, the augmented seed record can be queried by a server for identifying websites for a search query.

FIG. 6 is an exemplary illustration of a database and webpages.

Consider a set of records (R) 605. The R 605 includes two records r1 and r2 including the name, address and contact attributes of restaurants. Consider the two restaurant web pages p1 (610) and p2 (615) from a new web site. The name, address and contact of the restaurants are provided at the top of the web pages, and the nearest transit station and related restaurants are listed at the bottom. The name attribute, “Beijing” is misspelled as “Bejing” in pages p1 and p2. Similarly, in the address attribute, the terms “Avenue” and “Street” are abbreviated to “Ave” (in p1) and “St” (in p2), respectively, and an additional line starting with “(between” is uniformly inserted in both pages. In the FIG. 6, the position of name, address, contact, nearest transit station and related restaurants are denoted as 620, 625, 640, 630, and 635 respectively. For simplicity, the positions 620, 625, 630, 635, and 640 will herein be denoted as 1, 2, 3, 4 and 5 respectively.

By determining similarity scores between the attribute values of a seed record R and of the web pages p1 (610) and p2 (615) respectively, the attribute-position pair are identified as (name, 1), (name, 4), (address, 2), (address, 3) and (contact, 5).

The pairs of records (record, page) with strongly similar values for the various attribute-position pairs are as follows:

SS(name,1)={(r1,p1),(r2,p2)}.

SS(name,4)={(r2,p1),(r1,p2)}.

SS(address,2)={(r1,p1),(r2,p2)}.

SS(address,3)={(r1,p1)}.

SS(contact,5)={(r1,p1),(r2,p2)}

Where, SS refers to pairs of record with strongly similarity scores.

Let the minimum support parameter β=1. The support of all five attribute-position pairs above is at least β. Hence, the five attribute-position pairs are grouped in sets that are as follows: S1={(name, 1), (address, 2)}, S2={(name, 1), (address, 3)}, S3={(name, 4), (address, 2)}, S4={(name, 4), (address, 3)}, S5={(name, 1), (contact, 5)}, S6={(name, 4), (contact, 5)}, S7={(address, 2), (contact, 5)}, S8={(address, 3), (contact, 5)}.

The support for the sets is found by determining number of pairs of records that are common in the two attribute-position pairs of that set. For the set S1, both the pairs of records are common in the attribute-position pair (name, 1) and attribute-position pair (address, 2) of the set S1. Hence, the support for the set S1 is 2. Similarly, the sets S5 and S7 have support 2. Further, the sets S2 and S8 have support 1 since only single pairs of records are common in two attribute-position pairs of those sets. The sets S3, S4 and S6 have zero support since no pairs of records are found to be common in two attribute-position pairs of those sets.

Upon pruning sets that do not have the minimum support β, the sets S1, S5 and S7 are selected for next round of grouping.

S1={(name,1),(address,2)}

S5={(name,1),(contact,5)}

S7={(address,2),(contact,5)}

The next round of grouping is performed by using an Apriori style algorithm. We determine the supersets using the groups S1, S5 and S7 that have support greater than the minimum support (3. Using the Apriori Algorithm, we determine optimal set as

P1={(name,1),(address,2),(contact,5)}

Further, no group having four or more attribute-position pairs with different attributes is possible and an optimal solution is reached with maximum possible set of unique attribute-position pairs. Hence pairs of records corresponding to common attribute-position pairs of the superset P1 are extracted.

The method of extracting records based on matching records is unsupervised once manual annotations of a few initial websites are performed to generate an initial set of records in a database. Over a period of time, populating of database will ensure a sufficient overlap between the set of records and the any new websites. Thus ensuring faster extraction of the records. Moreover, any variations in web structure or content formats can be handled since the method of extraction is based on matching of actual attribute values. Furthermore, the matching can be performed for text as well as non-text attributes.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method comprising:
generating, electronically, a plurality of sets of pairs of records from a set of records, the plurality of sets of pairs of records comprising a first set of pairs of records and a second set of pairs of records, each pair of records from the first set of pairs of records having a similarity score greater than a first threshold for a first attribute-position pair in that pair of records and each pair of records from the second set of pairs of records having a similarity score greater than the first threshold for a second attribute-position pair in that pair of records, each attribute-position pair being indicative of a position of an attribute in a record;
performing generating sets of pairs of records for each attribute-position pair in the set of records;
forming, electronically, a plurality of groups, each group comprising two attribute-position pairs having different attributes;
for each group determining, electronically, number of pairs of records that are common in the two attribute-position pairs of that group; and
extracting results based on a first group of the plurality of groups if the number of pairs of records that are common in the two attribute-position pairs of the first group is greater than a second threshold, is highest among the plurality of groups, and no group having three or more attribute-position pairs with different attributes is possible.

2. The method of claim 1, wherein the first attribute-position pair and the second attribute-position pair correspond to a same attribute at different positions.

3. The method as claimed in claim 1 and further comprising:
repeating forming, determining and extracting for next highest number of attribute-position pairs having different attributes if possible.

4. The method as claimed in claim 1, wherein each pair of records comprises:
a record stored in a database; and
a webpage.

5. The method of claim 1 and further comprising:
regenerating sets of pairs of records for each attribute-position pair in the set of records if the number of records in each set of pairs of records is greater than a predefined threshold.

6. A method for extracting results, the method comprising:
computing, electronically, a first set of similarity scores between attribute values of a seed record and of a web page, the seed record comprised in a set of seed records and the web page comprised in a set of web pages;
performing computing for each record in the set of seed records and each web page in the set of web pages to generate a plurality of sets of similarity scores, the plurality of set of similarity scores comprising the first set of similarity scores;
for a first position of a first attribute in the set of web pages
identifying, electronically, number of web pages for which attribute values at the first position match that in the set of seed records based on the plurality of sets of similarity scores;
determining, electronically, the first position of an attribute as a correct position if the number of web pages for which attribute values at the first position match that in the set of seed records is greater than a threshold;
performing identifying and determining for each position of each attribute in the set of web pages to determine correct position for each attribute, the correct position comprising first position for the first attribute;
extracting web pages from the set of web pages based on the first position of the first attribute, the web pages having attribute value in the first position similar to that in a seed record of the set of seed records for the first attribute; and
performing extracting for each correct position for each attribute.

7. An article of manufacture comprising:
a machine-readable medium; and
instructions carried by the machine-readable medium and operable to cause a programmable processor to perform:
generating, electronically, a plurality of sets of pairs of records from a set of records, the plurality of sets of pairs of records comprising a first set of pairs of records and a second set of pairs of records, each pair of records from the first set of pairs of records having a similarity score greater than a first threshold for a first attribute-position pair in that pair of records and each pair of records from the second set of pairs of records having a similarity score greater than the first threshold for a second attribute-position pair in that pair of records, each attribute-position pair being indicative of a position of an attribute in a record;
performing generating sets of pairs of records for each attribute-position pair in the set of records;
forming, electronically, a plurality of groups, each group comprising two attribute-position pairs having different attributes;
for each group determining, electronically, number of pairs of records that are common in the two attribute-position pairs of that group; and
extracting results based on a first group of the plurality of groups if the number of pairs of records that are common in the two attribute-position pairs of the first group is greater than a second threshold, is highest among the plurality of groups, and no group having three or more attribute-position pairs with different attributes is possible.

8. The article of manufacture as claimed in claim 7, wherein the first attribute-position pair and the second attribute-position pair correspond to a same attribute at different positions.

9. The article of manufacture as claimed in claim 7 and further comprising instructions operable to cause the programmable processor to perform:
repeating forming, determining and extracting for next highest number of attribute-position pairs having different attributes if possible.

10. The article of manufacture as claimed in claim 7, each pair of records comprises:
a record stored in a database; and
a webpage.

11. The article of manufacture as claimed in claim 7 and further comprising instructions operable to cause the programmable processor to perform:
regenerating sets of pairs of records for each attribute-position pair in the set of records if the number of records in each set of pairs of records is greater than a predefined threshold.

12. A system comprising:
a communication interface in electronic communication with a network to receive records;
a memory for storing instructions; and
a processor responsive to the instructions to generate a plurality of sets of pairs of records from the set of records, the plurality of sets of pairs of records comprising a first set of pairs of records and a second set of pairs of records, each pair of records from the first set of pairs of records having a similarity score greater than a first threshold for a first attribute-position pair in that pair of records and each pair of records from the second set of pairs of records having a similarity score greater than the first threshold for a second attribute-position pair in that pair of records, each attribute-position pair being indicative of a position of an attribute in a record;
perform generating sets of pairs of records for each attribute-position pair in the set of records;
form a plurality of groups, each group comprising two attribute-position pairs having different attributes;
for each group determine a number of pairs of records that are common in the two attribute-position pairs of that group; and
extract results based on a first group of the plurality of groups if the number of pairs of records that are common in the two attribute-position pairs of the first group is greater than a second threshold, is highest among the plurality of groups, and no group having three or more attribute-position pairs with different attributes is possible.

13. The system of claim 12 and further comprising:
a storage device, in electronic communication with the server for storing the set of records.

14. The system as claimed in claim 12, wherein the processor is further responsive to the instructions to:
repeat forming, determining and extracting for next highest number of attribute-position pairs having different attributes if possible.

15. The system as claimed in claim 12, wherein the processor is further responsive to the instructions to:
regenerate sets of pairs of records for each attribute-position pair in the set of records if the number of records in each set of pairs of records is greater than a predefined threshold.
